(19) United States
(12) Patent Application Publication
(10) Pub. No.: US 2021/0354184 A1
(43) Pub. Date: Nov. 18, 2021

(54) METHOD FOR MANUFACTURING A SPATIALLY STRUCTURED PRODUCT, SEMI-FINISHED PRODUCT FOR THE PRODUCTION OF SUCH A PRODUCT AND PRODUCT WITH A SPATIALLY STRUCTURED SURFACE

(71) Applicants: KARLSRUHER INSTITUT FÜR TECHNOLOGIE (KIT), Eggenstein-Leopoldshafen (DE); IPU Ingenieurgesellschaft Braunschweig mbH, Braunschweig (DE)

(72) Inventors: Thomas UMMENHOFER, Karlsruhe (DE); Michael Philipp RZEPECKI, Karlsruhe (DE)

(21) Appl. No.: 17/288,737

(22) PCT Filed: Oct. 30, 2019
(86) PCT No.: PCT/EP2019/079723

§ 371 Date: Apr. 26, 2021

(30) Foreign Application Priority Data
Nov. 5, 2018 (DE) 10 2018 218 842.4

(51) Int. Cl. B21D 11/08; B21D 13/00; B21D 26/021; B21D 26/059; B29C 53/00; B29C 53/06

(52) U.S. Cl. CPC B21D 11/08; B21D 13/00; B29C 53/063; B21D 26/059; B29C 53/005; B21D 26/021

(57) ABSTRACT

The present invention relates to a method for manufacturing a product with a spatially structured surface from a semi-finished product, a semi-finished product required for this purpose and a product produced in this way. The method is characterized in that a patterned target bending location is produced in the semi-finished product, and in that the semi-finished product is then subjected to a pressure over its surface, which is dosed in such a way that the pressure causes a plastic deformation of the semi-finished product along the target bending location, so that a product with a spatially structured surface is produced.

The present invention relates to a method for manufacturing a product with a spatially structured surface from a semi-finished product, a semi-finished product for plastic forming thereof into a product with a spatially structured surface, and such a product.

Semi-finished products are to be understood as intermediate goods which consist of a raw material and which have already been brought into a basic geometric shape. In particular, semi-finished products within the meaning of the present application are plates, shells and/or discs made of metal, plastic, wood, artificial stones and/or mixtures thereof.

A spatially structured surface is to be understood as a surface that is characterized by different depths and heights, creases, bumps and/or elevations compared to a smooth unmachined surface.

In order to produce products with a spatially structured surface from a semi-finished product, it is usually necessary to perform a corresponding forming operation, which is usually introduced into the semi-finished product by means of deep drawing or mechanical folding processes. Products with such surfaces are also sometimes milled from the solid. However, as the spatial structure increases, the necessary forming energy increases strongly, which means that considerable forces are introduced into the semi-finished product, especially in the case of complex or pronounced geometries of the product. This can be a disadvantage, particularly in the case of semi-finished products made from composite plates, since the multilayer structure should not be destroyed in order to ensure the function of the composite plate even after forming. In the case of solid plates, the main disadvantage is that with increasing thickness, even greater amounts of energy are required to process the semi-finished product accordingly.

To counter this problem, in the prior art several separate semi-finished parts are usually assembled to form a complete product. Occasionally, cuts are also made in the semi-finished product to interrupt a force flow in the material of the semi-finished product. In both cases, the approach is to interrupt force flows in the semi-finished product by means of cut edges.

In many cases, the production of the cuts is quite complex and often such cut edges are also undesirable. This is the case, for example, when the spatially structured surface is intended to create specific visual impressions while at the same time fulfilling functional tasks, such as the impermeability or function of a full-surface covering, a facade part, cabinet element or the like. In such cases, it is particularly desirable for the product to have a surface that is as uniform as possible and free of gaps.

With this background, it is the task of the invention to demonstrate a considerably simplified method for manufacturing a product with a spatially structured surface and a semi-finished product for plastic forming of the same into a product with a spatially structured surface.

The solution of the task is achieved with the method according to claim 1 and the semi-finished product according to claim 16 as well as the product according to claim 32. Advantageous further embodiments of the invention are described in the respective subclaims.

The method according to the invention is therefore characterized by the fact that a patterned target bending location is created in the semi-finished product, and that the semi-finished product is then subjected to a pressure over its surface which is dosed in such a way that the pressure causes plastic deformation of the semi-finished product along the target bending location, so that a product with an overall spatially structured surface is produced.

The method according to the invention thus initially starts with the generation of a relatively complexly shaped target bending location in the semi-finished product. In general, the target bending location is a local reduction of the bending stiffness of the semi-finished product generated in any way, e.g. by weakening the thickness, but always along a pattern. This can be a regular and/or irregular pattern. The pattern of the structural weakenings or the target bending location can consist of any known basic geometries and/or of free geometries. It may be patterns within patterns. It can consist of linear, non-linear, of intersecting and/or non-intersecting lines, polylines, splines, circles, etc. Logos, fonts, drawings are also possible.

It is particularly important that a more complex shape of the target bending location is produced compared with a simple, e.g. linear shape, along which a relatively large-area plastic deformation then occurs in a subsequent method step of pressure application or forming, which can be carried out all the more quickly for this. In this way, the spatially structured surface can be produced very simply and quickly.

The plastic forming process therefore only has to be performed to overcome the locally reduced bending stiffness in the target bending location and no longer to overcome the bending stiffness of the original semi-finished product without target bending location. This means that considerably simpler and lower-energy forming processes can be used.

In this context, pressure is generally understood to mean a force per unit area applied to the semi-finished product during forming, which acts on at least one surface of the semi-finished product. It is important that this two-dimensional application of force results in a pressure gradient in the semi-finished product which leads to forming. Depending on how pronounced the target bending locations are, the pressure required for plastic forming can be correspondingly low. The application of the pressure or the associated forming can be carried out by using any suitable means. For example, a differential pressure device may be used. Also, the applied pressure can be a negative or positive pressure.

In particular, it is advantageous that the forming process does not have to be set up exactly to the geometry of the patterned target bending location, as is the case, for example, with the deep-drawing process or a pressing process. In particular, no special stamp geometries or molded parts have to be produced in order to produce the desired shape of the semi-finished product. Rather, it is the case that the various partial surfaces simply form along the pattern of the target bending location when the appropriate forming work is applied. The shape of the pattern of the target bending location does not have to correspond exactly to the partial surfaces to be produced. Rather, the pattern provides a basic structure along which the partial surfaces are formed. The spatially structured surface is therefore to be regarded as the sum of the partial surfaces that are formed on the basis of the inserted target bending location.

The specific introduction of a patterned target bending location is based on the knowledge that the relatively complex structure of the target bending location can be introduced into the undeformed semi-finished product with relatively little effort before the forming process. At the same time, the local plastic deformation that occurs along this patterned target bending location leads to the formation of a spatially stabilized surface in virtually a single step, despite any weakening of the cross section. This is also due to the fact that a larger number of partial surfaces are formed during forming as a result of the patterned target bending location. These form a mutually stabilizing, spatial surface structure of offset partial surfaces that compensates for the original cross-sectional weakening. If care is taken to ensure that the target bending location does not cut through or perforate the semi-finished product, the result is still a closed surface even after forming.

In other words, the patterned target bending location forms a folding structure with a spatially multi-structured surface during forming, which results in a high strength of the product due to the spatial stabilization of the folding structure created in this way. This is greater than the strength that would be achieved with only a single fold of a conventional target bending location.

The patterned target bending location is further produced by arranging at least one recess, which preferably extends from a surface of the semi-finished product in the direction of the interior of the semi-finished product or vice versa, in the semi-finished product. The recess can be formed by a recess of any desired cross-section. For example, a V-shape, a U-shape, a rectangular shape, a semicircular shape, etc. is conceivable.

It is particularly advantageous if at least one recess is at least partially linearly and/or several recesses are arranged along an imaginary line. The recesses can therefore be at least partially groove-like. In this way, patterned target bending locations can be created in the semi-finished product in a simple manner.

At least one linear recess can be at least partially rectilinear and/or curved, in particular spiral. Linear recesses with a straight course are particularly easy to manufacture.

It is also conceivable that several recesses are arranged along at least one at least straight and/or partially curved line in the semi-finished product. Thus, with several recesses aligned in such a specific manner, a patterned target bending location can also be created in a simple manner.

Advantageously, at least one recess is created in the semi-finished product in such a way that its depth and/or width changes at least partially along the pattern of the target bending location. For example, the recess can be more pronounced or less pronounced in the edge region of the surface of the semi-finished product than in the central region of the semi-finished product. Alternatively, and/or additionally, specific individual lines, curves of the recess or a subset of recesses may be more pronounced or weaker than lines, curves or subsets of recesses at other locations on the semi-finished product. This has the advantage that the subsequent contour of the product with a spatially structured surface can thus be specified even more precisely, since the extent of the forming correlates with the intensity with which the recess is formed.

Due to the structural weakenings with different depths and/or widths introduced in this way, the reduced cross sections of the semi-finished product have correspondingly reduced stiffnesses with a progression along the pattern of the target bending location. In the subsequent forming process, there are correspondingly different resistances in the pattern of the target bending location which have to be overcome to “buckle out” along the weakenings. Depending on the residual cross section, therefore, a different defined critical forming pressure is required. Areas with a small residual cross section will buckle early at low forming pressures, areas with a larger residual cross section only at higher forming pressures. Thus, the course of the forming process or the setting of the forming geometry can be controlled by a specific arrangement but also by the shaping of the structural weakenings as a function of the residual cross section. This enormously increases the design scope, ensures the reproducibility of the shapes and enables smooth transition areas within the structure weakening geometry. Critical forming areas can be localized by numerical analysis and early failure can be prevented by appropriate selection of the geometries of the recess or the target bending location.

The patterned target bending location can be at least partially designed as a spiral structure. The spiral structure can be angular and/or round. In any case, conically bulged products can be produced in a very simple manner.

Also, the patterned target bending location can be designed at least partially as a meshed structure, preferably with an open-cell and/or closed-cell structure. By meshed structure is meant in general a pattern composed of several lines (straight as non-straight) and/or points. Thus, the meshed structure can be created by one or more appropriately shaped line-shaped recesses or also by a plurality of punctiform and/or short line-shaped recesses set along imaginary lines. The areas correspondingly outlined by the recess or recesses can be compared to cells or meshes of a net. During forming, the surfaces defined in this way ensure that a number of partial surfaces, which move out of the original shape (which can be a flat surface but also a simple shell shape) of the semi-finished product and are angled towards each other, are formed.

In this context, the meshed structure of the patterned target bending location can at least partially have a closed-cell and/or open-cell structure. The closed-cell structure has the advantage over an open-cell structure that the mesh structure is defined by a weakened cross-section along the complete circumferential line of the cell. Thus, during forming, it is relatively well ensured that relatively clearly defined partial surfaces angled towards each other are formed. The open-cell structure has the advantage that, especially in relatively close-meshed patterns, not too many recesses meet in a node. A mixture of both structures combines their advantages.

A particularly suitable meshed structure is a polyhedral pattern, which can, for example, be made up of triangles or contain triangles. Thus, any variations of polygons can be present in the pattern. By using polyhedral patterns, so-called stealth surfaces can be created in the product.

Preferably, the recess is formed thermally, mechanically, chemically and/or by applying material next to the target bending location. Thermal manufacturing may be understood to mean, for example, a melting or baking of the recess. Mechanical manufacturing may be understood to mean, for example, a machining, displacement or similar process. Chemical manufacturing, for example by etching, is also conceivable. The machining processes include processes with a geometrically determined cutting edge, such as screwing, drilling, countersinking, milling and broaching, as well as those with a geometrically undetermined cutting edge, such as grinding honing, lapping, beam machining and sliding machining. A displacing process is understood to mean, for example, the pressing of a profile or geometry into a surface of the semi-finished product. The advantage here is the cost-effective use of such processes for processing the semi-finished product. The term material application covers all processes which apply an additional layer, coating or other object to the surface which results in an increase in the bending stiffness at the point in question—i.e. next to the bending location.

Advantageously, overpressure and/or underpressure is applied to at least one surface of the semi-finished product. In particular, the pressure can be applied variably, uniformly and/or alternately. A variable pressure is generally understood to mean a time-dependent pressure gradient which occurs during forming. In particular, the variable pressure can exhibit gradual, uniform and/or abrupt pressure changes. The pressure change can be either purely in the overpressure or underpressure range, or alternating from the overpressure to the underpressure range or vice versa. A variable pressure has the advantage that the plastic forming can be controlled or triggered more precisely.

Further, a pressure medium is used to apply the pressure. This can be a fluid, a foam, a sand, a plate with an elastic surface and/or the like. The fluid can be compressible, such as a gas, gas mixture, in particular air, or incompressible, such as a liquid, in particular water, or an oil, in particular a hydraulic oil. The use of a fluid, has the advantage that a locally constant pressure is achieved over the surface of the semi-finished product. As no pressure peaks are formed, the forming of the semi-finished product is more predictable and gentle on the material.

It may be useful to apply a protective cover to at least one of the first surface and/or the second surface of the semi-finished product before applying pressure to the semi-finished product. By a protective cover is meant, in very general terms, a sheet or layer which makes it possible to prevent the pressure medium from coming into direct contact with the semi-finished product surface in question during the forming process. This can have several advantages. Firstly, it can ensure that the pressure medium does not escape during forming through any perforations that may be present in the semi-finished product. Secondly, wetting or direct contact in general between the pressure medium and the semi-finished product surface can be avoided. The protective cover is preferably applied after insertion of the target bending location and before forming of the semi-finished product.

It may be useful for the semi-finished product to be formed against a damping means. The damping means can be an elastic object which comes into contact with the semi-finished product during the entire forming process or only towards the end of the forming process. The damping means can be arranged statically or carried along during the forming process. Advantageously, excessive forming of the semi-finished product in places or over large areas can be avoided and the forming process as a whole can be better controlled. This is particularly helpful if the forming takes place at high strain rates, quickly and/or generated by high amounts of energy.

In a preferred further development, the semi-finished product and/or a pressure medium is heated in such a way that the plastic forming of the semi-finished product is favored. The heating can have a purely material-related influence on the bending stiffness of the semi-finished product, which is the case, for example, when a softening temperature is reached, or a reaction-related influence, which means that when the temperature limit is reached a chemical process takes place which reduces the bending stiffness of the semi-finished product.

Preferably, two layers of the semi-finished product are joined together to manufacture the product in such a way that sufficient pressure for forming can be applied between the two layers of semi-finished product. In this case, plastic deformation occurs in accordance with the target bending location, which is introduced on at least one surface of the multilayer semi-finished product. The advantage here is that for example a cushion-like surface structure can be produced with little effort.

On the equipment side, the problem can be solved with a semi-finished product for plastic forming into a product with a spatially structured surface which has a patterned target bending location with at least one recess. The advantages already described above with regard to the method are achieved here.

Preferably, the at least one recess of the patterned target bending location extends from a surface of the semi-finished product in the direction of the interior of the semi-finished product or vice versa. Also, the target bending location may further comprise a second recess extending from a second surface of the semi-finished product towards a first surface of the semi-finished product or vice versa. The second recess may thereby comprise a single recess or a plurality of recesses. Preferably, the second recess may also comprise a pattern, such as a polyhedral pattern. In order to support the forming process, the second recess can be arranged congruently with the first recess in the semi-finished product. This results in a cross-sectional weakening that is effective from both sides. Alternatively, it can also be arranged offset to it. In this way, additional kinks can be created in the surface of the semi-finished product. As previously described, the target bending location also comprises both the first and the second recesses in the sense of this further embodiment. It is essential to the invention that the target bending location provides the basic pattern for the subsequent spatially deformed surfaces of the product.

In an expedient manner, the patterned target bending location has at least one recess which is linear and has an at least partially rectilinear and/or curved, in particular spiral, course.

The patterned target bending location can also have several recesses arranged along an at least partially rectilinear and/or curved line. Then several specifically aligned recesses form the patterned target bending location in its entirety.

Advantageously, the patterned target bending location has at least one recess whose depth and/or width changes at least partially along the pattern. For example, the recess can be more pronounced or less pronounced in the edge region of the surface of the semi-finished product than in the central region of the semi-finished product. Alternatively, and/or additionally, specific individual lines, curves of the recess or a subset of recesses may be more pronounced or less pronounced than lines, curves or subsets of recesses at other locations on the semi-finished product. This has the advantage that the subsequent contour of the product with a spatially structured surface can thus be specified even more precisely, since the extent of the forming correlates with the intensity with which the recess is formed.

It is further advantageous that the target bending location has at least one recess in the form of a perforation. The perforation can be continuous or only partially continuous. The perforation can be introduced both along a specific fold or a corner of a polyhedron. The perforation can be introduced perpendicularly or inclined with respect to the semi-finished product surface. If the perforation is not continuous, it can be present both from one surface and from both surfaces of the semi-finished product. It is always advantageous that the perforation, as part of the target bending location, represents a particularly simple weakening of the bending stiffness.

A cross-section of the recess can also be designed in such a way that when the semi-finished product reaches a defined forming angle α at the recess, further forming of the semi-finished product is inhibited by the formation of a touch contact in the cross-section of the recess. A touch contact can be understood, for example, as a stop of two flanks of the recess. For example, this can be done by the recess having a U-shaped or V-shaped cross section, which is formed accordingly. This has the advantage that not only the start of the forming is initiated by the recess, but also the end of the forming is predetermined by the recess.

The semi-finished product is advantageously made of a thermally, chemically and/or mechanically activatable plastic. By activatable plastic is meant a plastic that is plastically deformed by thermal, chemical and/or mechanical influence. It can therefore be a thermoplastic, for example. The use of reactive plastic has the advantage that the bending stiffness of the target bending location can be at least temporarily reduced or increased by a specific chemical reaction.

According to an advantageous further development, the semi-finished product comprises a composite material having at least an outer layer and a core layer, the patterned target bending location being arranged in at least one of the layers. A suitable composite material may have an outer layer and/or a core layer of metal, ceramic, glass, stone (natural stone and/or artificial stone), plastic and/or wood or mixtures thereof. For example, a known and well-suited composite material has two outer layers of aluminum and a core layer of a polymer plastic, a well-known trade name for which is Alucobond. Composite materials generally have the advantage that different material properties can be bundled. For example, they can have high bending stiffness, high flatness and weather resistance in the outer layer with an overall light weight due to a lightweight core layer.

Preferably, the first and/or second recess of the target bending location penetrates an outer layer at least partially. This is particularly advantageous in the case of a material in the outer layer that is particularly resistant to bending, as it makes forming much easier.

It can also be useful if the semi-finished product has two interconnected semi-finished product layers, at least one of the semi-finished product layers having a target bending location. It may be useful for the manufacture of the same that a suitable means for introducing the pressure is arranged on at least one semi-finished product layer. This may be a fluid filler neck for supplying the pressure medium. After plastic forming, the pressure medium can be discharged from the multilayer semi-finished product. The pressure medium can be, for example, air, which is temporarily pressed into the empty space between the semi-finished product layers or sucked out to such an extent that a pressure sufficient for plastic forming is generated. In all the cases described, the patterned target bending location can be formed in whole or in part on at least one of the surfaces of a semi-finished product layer.

Alternatively, the two layers of semi-finished product can be connected by a frame-like bar running around the edge, so that a defined initial distance is established between the two layers. A deformed structure (convex, concave, mixed convex-concave) can then be produced by applying overpressure or underpressure or alternating overpressure and underpressure. In order to be able to introduce the overpressure, for example with a fluid, between the two semi-finished product layers, a valve can be arranged in the frame-like bar.

Accordingly, a semi-finished product, which already has an internal cavity in its initial state, can also be formed. At least one spacer can also be introduced into such a cavity. If a vacuum is then generated, the respective spacer presses into the semi-finished product and in this way generates an additional deformation effect by the spacer limiting the deformation at the point.

The patterned target bending locations can be located on all main surfaces of the two semi-finished product layers. However, any combination of surfaces on which a patterned target bending location is formed is conceivable. In a preferred further development, the patterned target bending location is formed on both inward-facing semi-finished product layers. This has the advantage that the patterned target bending locations are not visible from the outside.

Finally, the solution to the problem is also achieved with a product having a spatially structured surface which has been produced from a semi-finished product as described above and/or by such a method. Here, too, the advantages described above are achieved.

The invention is explained in more detail below with reference to several embodiments shown in the drawings. Therein schematically show:

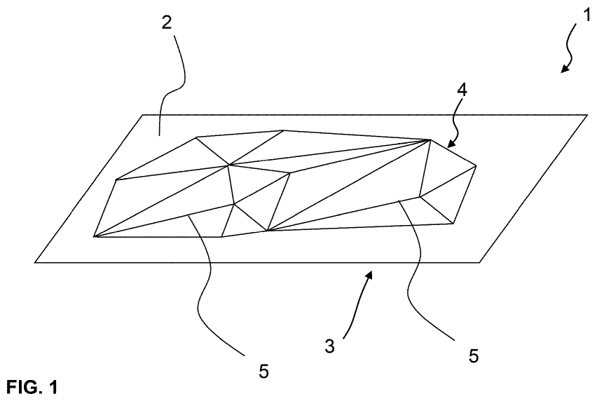

FIG. 1 a perspective overall view of a semi-finished product according to the invention;

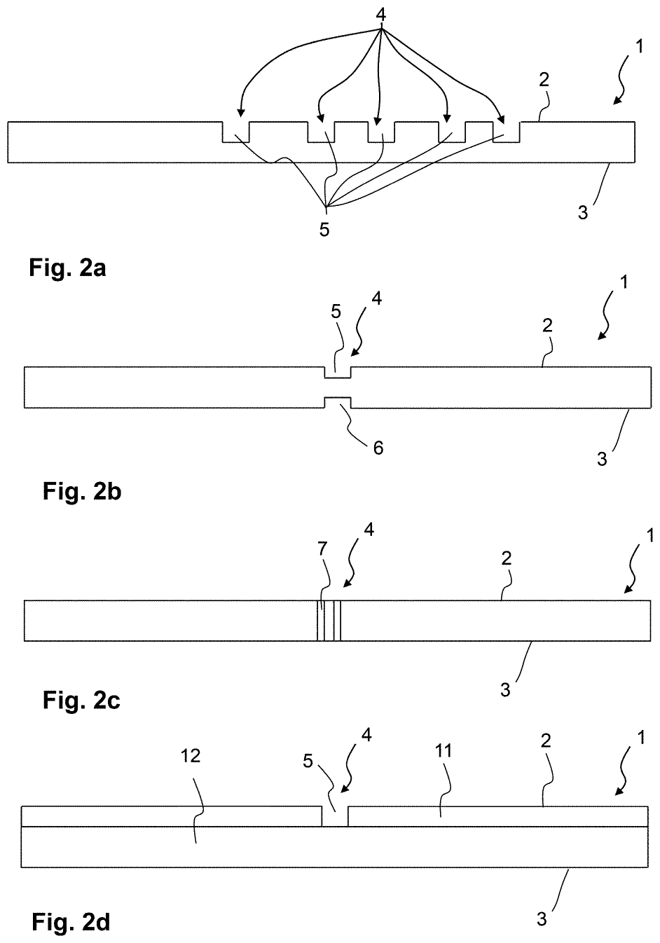

FIG. 2a to FIG. 2d four cross-sectional views of different semi-finished products according to the invention in accordance with a second to fifth embodiment;

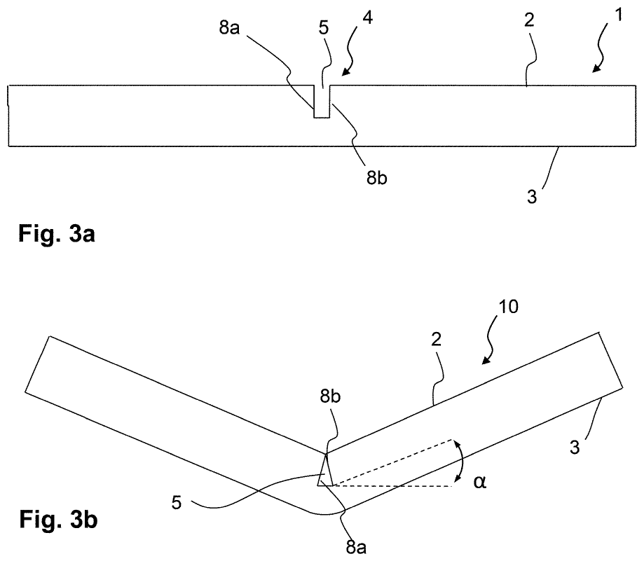

FIG. 3a a semi-finished product according to a sixth embodiment in a state prior to plastic forming into a product according to the invention;

FIG. 3b a semi-finished product according to the sixth embodiment in a state after plastic forming into a product according to the invention;

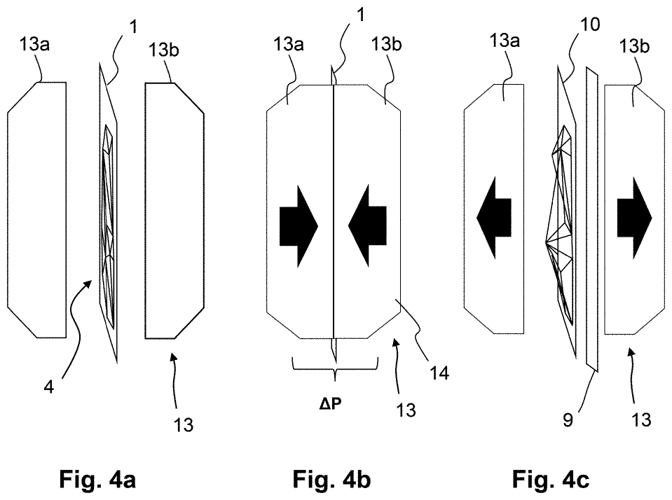

FIG. 4a to FIG. 4c the manufacturing method according to the invention by means of exemplary working steps;

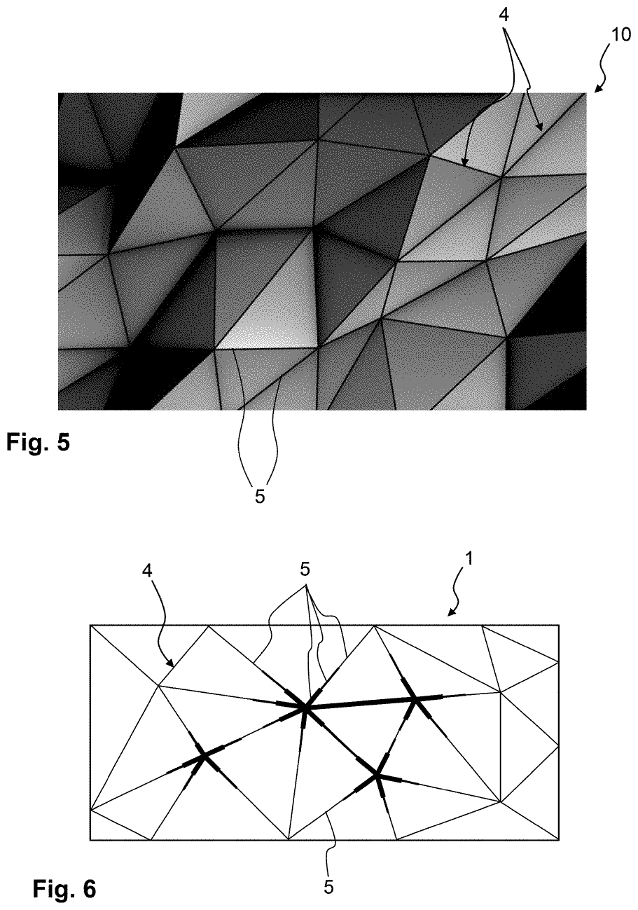

FIG. 5 a section of a top view of a product with a spatially structured surface produced by means of the manufacturing method according to the invention;

FIG. 6 a top view of a semi-finished product according to the invention with a patterned target bending location whose recesses partly have different depths;

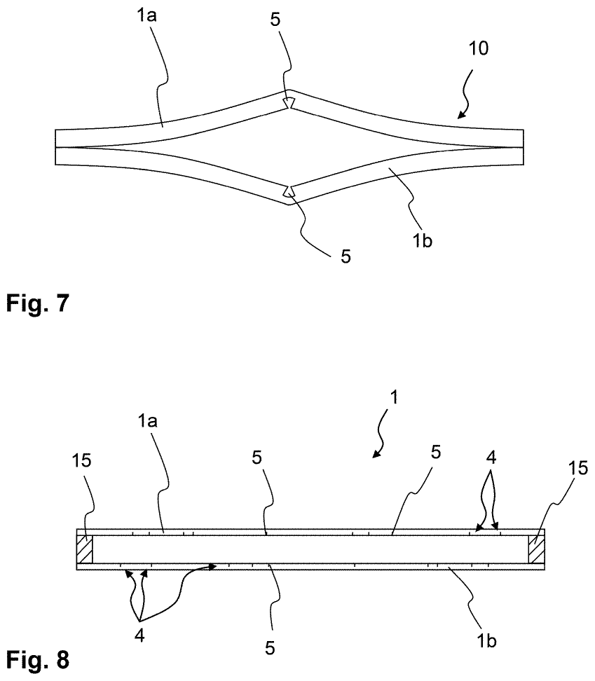

FIG. 7 a cross-section through a product made from two layers of semi-finished material according to the invention;

FIG. 8 a cross-section through a semi-finished product made from two layers of semi-finished product connected by a frame-like bar; and

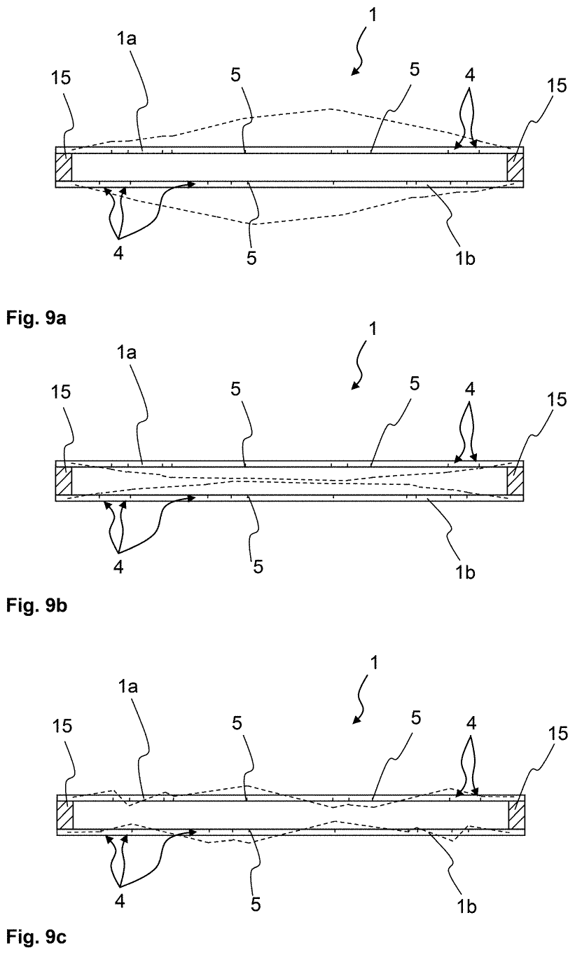

FIGS. 9a to 9c the cross-section shown in FIG. 8 with three different resulting product shapes after forming indicated by dashed lines;

The semi-finished product 1 shown in FIG. 1 is a flat, rectangular plate (e.g. of metal) which is flat in its initial state and has a first surface 2 facing upwards and a second surface 3 facing downwards. According to the invention, a target bending location 4 is now formed on the surface 2 of the semi-finished product 1 in the form of a meshed structure in plan view. In the embodiment shown here, this meshed target bending location comprises a plurality of interconnected linear recesses 5, all of which extend from the first surface 2 in the direction of the second surface 3 of the semi-finished product 1 into the latter. Each recess 5 causes a local reduction in the bending stiffness of the semi-finished product 1, as a result of which a product 10 with a spatially structured surface can be formed when sufficient pressure is applied to the semi-finished product 1.

Since the meshed target bending location 4 has a polyhedral pattern in the plan view of the plate-shaped semi-finished product 1 (in this example, made up of several triangles), a correspondingly spatially structured surface in the form of a polyhedrically structured spatial pattern will also be formed as a result of the forming process. This will therefore consist of a large number of polyhedron surfaces angled towards each other, also in spatial dimension.

FIG. 2a shows a cross-sectional view of a second embodiment of a semi-finished product 1 according to the invention with a target bending location 4 formed by several recesses 5. In this case, the semi-finished product 1 is, like the first embodiment shown in FIG. 1, a flat plate in which a plurality of first recesses 5 have been made on the first surface 2, which are shown here schematically as U-shaped recesses. Of course, the recesses 5 can also have completely different cross-sectional shapes, since the result of the forming can also be controlled via the cross-sectional shape of the recess 5. In the embodiment shown here, the recesses 5 each extend to about half the thickness of the semi-finished product 1, the depth also being selected only by way of example. The recesses 5 can be formed as a series of holes which follow an imaginary line. However, it is also conceivable that they extend linearly over the surface 2 of the semi-finished product 1, as in the embodiment shown in FIG. 1.

FIG. 2b illustrates a third embodiment of a semi-finished product 1, in which the target bending location 4 has a first recess 5 and a second recess 6. The first recess 5 extends from the first surface 2 in the direction of the second surface 3, and the second recess 6 extends from the second surface 3 in the direction of the first surface 2. In the section of the semi-finished product 1 shown here, only one recess 5 or 6 is shown in each case, although further recesses 5, 6 can of course be present in further areas. The recesses 5, 6 of the target bending location 4 are designed to be essentially identical and each extends about one third into the semi-finished product 1. The target bending location 4 thus has two recesses 5, 6 which are U-shaped in cross section and form a meshed structure in the plan view of the semi-finished product 1. Just as in the first embodiment, the constriction along the target bending location 4 leads to a reduced bending stiffness of the semi-finished product 1 in this area. The recesses 5, 6 on both sides are here arranged congruently on top of each other in the semi-finished product 1 as an example. It is also conceivable, however, that recess 5 could be deliberately displaced relative to recess 6.

FIG. 2c illustrates a fourth embodiment of a semi-finished product 1 with a meshed target bending location 4. In this case, the target bending location 4 has a perforation 7 in the section of the semi-finished product 1 shown, which extends from the first surface 2 to the second surface 3 of the semi-finished product, exemplarily as a continuous bore. The perforation 7 also causes a local reduction in the bending stiffness, as a result of which the semi-finished product 1 first deforms plastically at the relevant target bending location when sufficient pressure is applied to the first surface 2 or the second surface 3 of the semi-finished product 1.

In the embodiment shown in FIG. 2d, the semi-finished product 1 consists of a composite material with an outer layer 11 and a core layer 12. The outer layer 11 can consist of a relatively bending-resistant material, such as metal or wood, while the core layer 12 consists of a less bending-resistant material, such as a softer metal or plastic. In the present case, the first recess 5 of the target bending location 4 is applied to the first surface 2 of the semi-finished product 1 and completely penetrates the outer layer 11. This does not have to be mandatory, but facilitates the forming.

FIG. 3a illustrates a fifth embodiment of the semi-finished product 1 according to the invention in the state before plastic forming of the semi-finished product 1, while FIG. 3b shows the state after plastic forming and thus the finished product 10. Basically, the cross-sectional shape of recess 5 of this fifth embodiment is similar to the cross-sectional shape of recess 5 of the second embodiment shown in FIG. 2a. This is because both of them are U-shaped. However, the dimensions of the first recess 5, in particular the width or spacing of the flanks 8a and 8b of the recess 5, are deliberately selected to be smaller here. Thus, further forming is inhibited relatively early on when a certain forming angle α is reached during plastic forming of the semi-finished product 1.

FIGS. 4a to 4c now explain the manufacturing process in more detail using individual exemplary work steps. First, the semi-finished product 1 is positioned as a flat plate in a differential pressure device 13. In the embodiment shown here, the differential pressure device 13 has a left-hand pressure chamber 13a and a right-hand pressure chamber 13b. The semi-finished product 1 corresponds to that of FIG. 1 and has the same target bending location 4 formed as a polyhedral pattern. The actual application of a pressure to the semi-finished product 1 takes place inside the differential pressure device 13 after the semi-finished product 1 has been clamped between the left and the right pressure chambers 13a and 13b of the differential pressure device 13. The pressure chambers 13a and 13b are designed in such a way that, in the closed state, they allow spatial expansion of the semi-finished product 1 by plastic deformation.

In the drawing shown in FIG. 4b, the semi-finished product 1 is thus clamped between the left-hand pressure chamber 13a and the right-hand pressure chamber 13b of the differential pressure device 13 and a suitable pressure medium 14, such as compressed air, water, oil, etc., is applied to it in the right-hand pressure chamber 13b. The application of a pressure medium 14 takes place in such a way that a differential pressure is formed between the right-hand pressure chamber 13a and the left-hand pressure chamber 13b of the differential pressure device 13, which differential pressure is so great that the inserted semi-finished product 1 is plastically deformed along its target bending location 4 into the left-hand part 13a of the differential pressure device 13. The completed plastic deformation of the semi-finished product 1 into the product 10 is shown in FIG. 4c. It is also apparent from FIG. 4c that a protective cover 9 was inserted between the right-hand pressure chamber 13b and the semi-finished product 1, or the finished product 10, to prevent direct contact of the pressure medium 14 with the semi-finished product 1 during the manufacturing process. The arrangement of this protective cover 9 is not always necessary, but makes particular sense when, for example, there is a risk of undesirable influence of the pressure medium 14 on the semi-finished product 1.

FIG. 5 illustrates the spatially structured surface created in this way in the finished product 10. As can be seen from FIG. 5, the meshed target bending location 4, which is made of several linear recesses 5, now forms the edges of spatially angled polyhedra (in this case triangular surfaces). The polyhedra thus emerge spatially from the plane or shape of the original semi-finished product 1 and form a spatially structured surface, which in this example consists of individual angled triangular surfaces.

FIG. 6 shows an example of a semi-finished product 1 according to the invention with a patterned target bending location 4, some of whose recesses 5 have two to three different depths. These different depths are indicated in FIG. 6 by lines of different thickness. Thus, it is conceivable that a recess 5 initially has a depth of about one third of the thickness of the semi-finished product 1. This initial depth of the recess 5 then increases in the course of the recess towards a node point arranged centrally in the semi-finished product, in which several line-shaped recesses meet—for example to half the thickness of the semi-finished product 1. Close to the node point, the depth then increases to two thirds of the thickness of the semi-finished product 1, indicated by the thickest line in FIG. 6. The areas with the greatest depth of recess 5 will buckle correspondingly earlier during forming than the areas with a smaller recess depth. The variable depth of the recesses can considerably increase the design scope as already explained above.

FIG. 7 shows a sectional view of a further example of a finished product 10. This is a product 10 which has been produced from two layers of semi-finished material 1a and 1b joined at their edges. Due to the sectional view, only a first recess 5 per semi-finished product layer 1a and 1b can be seen here, although the two target bending locations 4 of the two semi-finished product layers 1a and 1b naturally have a patterned structure in the surface of the semi-finished product layers 1a and 1b.

The forming itself is performed by generating pressure between the two layers of semi-finished products 1a and 1 b, which are still flat and lying on top of each other in the initial situation. For this purpose, for example a liquid or gaseous pressure medium 14 is pressed between the two layers of semi-finished products 1a and 1b. Based on the highly simplified example, this results in a product 10 with a cushion-like shape, the surfaces of which are structured or folded in a multiple and meshed manner.

As can be seen in the example shown in FIG. 8, the two semi-finished product layers 1a and 1b can also be connected by a frame-like bar 15 at their outer edges. The target bending locations 4 of the two semi-finished product layers 1a and 1b, as shown here, can also be arranged not congruently one above the other in the semi-finished product layers 1a and 1b respectively.

As shown in FIG. 9a to FIG. 9c by means of three different examples, depending on how the pressure is applied between the two layers of semi-finished products 1a and 1b, quite different deformations can occur in the semi-finished products 1a and 1b. Thus, a convex outwardly curved product 10 can be obtained by applying a uniform overpressure between the two semi-finished product layers 1a and 1b, as indicated in FIG. 9a by means of the dashed line.

If a vacuum is introduced between the two semi-finished product layers 1a and 1b, the deformation pattern shown in FIG. 9b can result.

Alternating overpressure and underpressure can result in alternating inward and outward indentations in the semi-finished product layers 1a and 1b along the patterned target bending locations 4 and their recesses 5, as can be seen from the dashed line indicated in FIG. 9c.

### REFERENCE SIGNS

1 semi-finished product
1a first semi-finished product layer
1b second semi-finished product layer
2 first surface
3 second surface
4 target bending location with meshed structure
5 first recess
6 second recess
7 perforation
8a, 8b flanks of the recess
9 protective cover
10 product
11 outer layer
12 core layer
13 differential pressure device
13a left chamber
13b right chamber
14 pressure medium
15 α forming angle

1. A method for manufacturing a product with a spatially structured surface from a semi-finished product, wherein
at first a patterned target bending location is produced in the semi-finished product, and thereafter
the semi-finished product is subjected to a pressure over its surface which is dosed in such a way that the pressure causes a plastic deformation of the semi-finished product along the target bending location, so that a product with a spatially structured surface is produced.

2. The method according to claim 1, wherein
the patterned target bending location is produced by arranging in the semi-finished product at least one recess which preferably extends from a surface of the semi-finished product in the direction of the interior of the semi-finished product or vice versa.

3. The method according to claim 1, wherein
the at least one recess is produced in the semi-finished product in such a way that its depth and/or width changes at least partially along the pattern of the target bending location.

4. The method according to claim 1, wherein at least one recess is formed at least partially linearly and/or a plurality of recesses are arranged along an imaginary line.

5. The method according to claim 1, wherein at least one linear recess is at least partially rectilinear and/or curved, in particular spiral.

6. The method according to claim 1, wherein a plurality of recesses are arranged along at least one at least straight and/or partially curved line in the semi-finished product.

7. The method according to claim 1, wherein the patterned target bending location is designed at least partially as a meshed structure consisting of a plurality of recesses, preferably with an open-cell and/or closed-cell structure.

8. The method according to claim 1, wherein the meshed structure of the target bending location is at least partially implemented as a polyhedral structure.

9. The method according to claim 1, wherein the recess is produced thermally, mechanically, chemically and/or by applying material next to the target bending location.

10. The method according to claim 1, wherein an overpressure and/or underpressure is applied to at least one surface of the semi-finished product, the pressure being applied in particular variably, uniformly and/or alternately.

11. The method according to claim 1, wherein a pressure medium, which is preferably a gas, a fluid, a foam, a sand and/or a plate with an elastic surface, is used to apply the pressure.

12. The method according to claim 1, wherein a protective cover is applied to at least one surface of the semi-finished product before pressure is applied to the semi-finished product.

13. The method according to claim 1, wherein the semi-finished product is formed against a damping means.

14. The method according to claim 1, wherein the semi-finished product and/or a pressure medium is heated in such a way that the plastic forming of the semi-finished product is favored or made possible.

15. The method according to claim 1, wherein two layers of the semi-finished product are joined to one another in such a way that a pressure sufficient for forming can be applied between the two semi-finished product layers.

16. A semi-finished product for plastic forming thereof into a product having a spatially structured surface according to claim 1, wherein the semi-finished product has a patterned target bending location with at least one recess.

17. The semi-finished product according to claim 16,
wherein the at least one recess of the patterned target bending location extends from a surface of the semi-finished product in the direction of the interior of the semi-finished product or vice versa.

18. The semi-finished product according to claim 16, wherein the patterned target bending location has a second recess which extends from a second surface of the semi-finished product in the direction of a first surface of the semi-finished product.

19. The semi-finished product according to claim 16, wherein the patterned target bending location has at least one recess which is linear and has an at least partially rectilinear and/or curved, in particular spiral, course.

20. The semi-finished product according to claim 16, wherein the patterned target bending location has a plurality of recesses which are arranged along an at least partially rectilinear and/or curved line.

21. The semi-finished product according to claim 16, wherein the patterned target bending location has at least one recess whose depth and/or width changes at least partially along the pattern of the target bending location.

22. The semi-finished product according to claim 16, wherein the patterned target bending location has at least one recess formed as a perforation.

23. The semi-finished product according to claim 16, wherein a cross-section of the recess is formed in such a way that when the semi-finished product reaches a defined forming angle (α) at the recess, further forming of the semi-finished product is inhibited by a touch contact forming in the cross-section of the recess.

24. The semi-finished product according to claim 16, wherein the semi-finished product has a thermally, chemically and/or mechanically activatable plastic.

25. The semi-finished product according to claim 16, wherein the semi-finished product consists of a composite material comprising at least an outer layer and a core layer, wherein the patterned target bending location is arranged in at least one of the layers.

26. The semi-finished product according to claim 25, wherein at least one outer layer and/or the core layer are/is made of metal, ceramic, glass, stone, plastic and/or wood.

27. The semi-finished product according to claim 25, wherein at least one recess of the patterned target bending location at least partially penetrates an outer layer.

28. The semi-finished product according to claim 16, wherein it has two interconnected, overlapping semi-finished product layers, at least one of the two semi-finished product layers having a patterned target bending location.

29. The semi-finished product according to claim 27, wherein a suitable means for introducing a pressure medium is arranged on at least one semi-finished product layer.

30. The semi-finished product according to claim 28, wherein the two semi-finished product layers are joined by a frame-like bar running around their edge.

31. The semi-finished product according to claim 16, wherein it has an internal cavity.

32. A product with a spatially structured surface, wherein it has been produced from a semi-finished product and/or by a method according to claim 1.
